(19) United States
(12) Patent Application Publication
(10) Pub. No.: US 2011/0242005 A1
(43) Pub. Date: Oct. 6, 2011

(54) INTERACTIVE INPUT DEVICE WITH PALM REJECT CAPABILITIES

(75) Inventors: CHI MAN CHARLES UNG, Calgary (CA); Andrew Macaskill, Port Moody (CA); Luqing Wang, Calgary (CA)

(73) Assignee: SMART Technologies ULC, Calgary (CA)

(21) Appl. No.: 12/751,351

(22) Filed: Mar. 31, 2010

(51) Int. Cl. G06F 3/041

(52) U.S. Cl. 345/173

(57) ABSTRACT

An interactive input device comprises a panel formed of energy transmissive material and having an input surface, energy dispersing structure associated with the panel, the energy dispersing structure dispersing energy emitted by a pointer that enters the panel via the input surface and at least one imaging assembly, at least some of the dispersed energy being directed towards the at least one imaging assembly.

### FIELD OF THE INVENTION

The present invention relates generally to interactive input systems and in particular, to an interactive input device with palm reject capabilities.

### BACKGROUND OF THE INVENTION

Interactive input systems that allow users to inject input (eg. digital ink, mouse events etc.) into an application program using an active pointer (eg. a pointer that emits light, sound or other signal), a passive pointer (eg. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); touch-enabled laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking generally across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

In order to facilitate the detection of pointers relative to a touch surface in interactive input systems, various lighting schemes have been considered. U.S. Pat. No. 5,495,269 to Elrod et al. discloses a large area electronic writing system which employs a large area display screen, an image projection system, and an image receiving system including a light emitting pen. The display screen is designed with an imaging surface in front of a substrate. A thin abrasion resistant layer protects the imaging surface from the tip of the light emitting pen. The imaging surface disperses light from both the image projection system and the light emitting pen. The image receiving system comprises an integrating detector and a very large aperture lens for gathering light energy from the light spot created by the light emitting pen. The amount of energy from the light spot which reaches the integrating detector is more critical to accurate pen position sensing than the focus of the light spot, so that the aperture of the lens is more important than its imaging quality. The light emitting pen is modified to additionally disperse light at its tip.

U.S. Pat. No. 5,394,183 to Hyslop discloses a method and apparatus to input two dimensional points in space into a computer. Such points in space reside within the field of view of a video camera, which is suitably connected to the computer. The operator aims a focus of light at the point whose coordinates are desired and depresses a trigger button mounted proximate to the light source. Actuation of the trigger button signals the computer to capture a frame of video information representing the field of view of the video camera, and with appropriate software, identifies the picture element within the captured video frame that has the brightest value. This picture element will be the one associated with the point within the field of view of the video camera upon which the spot of light impinged at the time the trigger button was depressed. The actual digital coordinates of the point are identified and then calculated based upon a previously established relationship between the video frame and the field of view of the video camera.

U.S. Pat. No. 6,100,538 to Ogawa discloses an optical digitizer disposed on a coordinate plane for determining a position of a pointing object projecting light. A detector is disposed on a periphery of the coordinate plane and has a view field covering the coordinate plane for receiving the light projected from the pointing object and for converting the received light into an electric signal. A processor is provided for processing the electric signal fed from the detector to compute coordinates representing the position of the pointing object. A collimator is disposed to limit the view field of the detector below a predetermined height relative to the coordinate plane such that through the limited view field, the detector can receive only a parallel component of the light which is projected from the pointing object substantially in parallel to the coordinate plane. A shield is disposed to enclose the periphery of the coordinate plane to block noise light so that only the projected light from the pointing object enters into the limited view field of the detector.

U.S. Pat. No. 7,442,914 to Eliasson discloses a system for determining the position of a radiation emitter, which radiation emitter may be an active radiation emitting stylus, pen, pointer, or the like or may be a passive, radiation scattering/reflecting/diffusing element, such as a pen, pointer, or a finger of an operator. The radiation from the emitter is reflected from that position toward the detector by a reflecting element providing multiple intensity spots on the detector that yield sufficient information for determining the position of the radiation emitter. From the output of the detector, the position of the radiation emitter is determined.

In many interactive input systems that employ machine vision to register pointer input, when a user attempts to write on the touch surface using a pen tool and the user rests their hand on the touch surface, the hand on the touch surface is registered as touch input leading to undesired results. Not surprising, interactive input systems to address this problem have been considered. For example, U.S. Pat. No. 7,460,110 to Ung et al., assigned to SMART Technologies ULC, discloses an apparatus for detecting a pointer comprising a waveguide and a touch surface over the waveguide on which pointer contacts are to be made. At least one reflecting device extends along a first side of the waveguide and touch surface. The reflecting device defines an optical path between the interior of the waveguide and the region of interest above the touch surface. At least one imaging device looks across the touch surface and into the waveguide. The imaging device captures images of the region of interest and within the waveguide including reflections from the reflecting device. Although this interactive input system is satisfactory, improvements are desired.

It is therefore an object of the present invention at least to provide a novel interactive input device with palm reject capabilities.

### SUMMARY OF THE INVENTION

Accordingly, in one aspect there is provided an interactive input device comprises a panel formed of energy transmissive material and having an input surface, energy dispersing structure associated with the panel, the energy dispersing structure dispersing energy emitted by a pointer that enters the panel via the input surface and at least one imaging assembly, at least some of the dispersed energy being directed towards the at least one imaging assembly.

In one embodiment, the energy dispersive structure comprises light diffusive material. In one form, the light diffusive material comprises a diffusive layer having a footprint that is the same size or smaller than the footprint of the input surface. The input surface comprises an active input region corresponding generally in size to the diffusive layer. The input surface may be inclined or generally horizontal. The diffusive layer may be one of: (i) embedded within the panel; (ii) affixed to a surface of the panel; (iii) coated on a surface of the panel; and (iv) integrally formed on a surface of the panel. The diffusive layer may be positioned adjacent to the input surface or positioned adjacent to a surface of the panel that is opposite to the input surface. The interactive input device may comprise at least two spaced imaging assemblies, the imaging assemblies having overlapping fields of view, at least some of the dispersed energy being directed towards the imaging assemblies.

In another embodiment, the light diffusive material comprises spaced upper and lower diffusive layers. The upper and lower diffusive layers may be generally parallel. The upper diffusive layer has a footprint that is the same size or smaller than the footprint of the input surface. The input surface comprises an active input region corresponding generally in size to the diffusive layer. The lower diffusive layer has a footprint that is at least as large as the footprint of the upper diffusive layer. In one form, the lower diffusive layer has a footprint larger than the footprint of the upper diffusive layer. The at least one imaging assembly comprises upper and lower image sub-sensors. The upper diffusive layer is within the field of view of the upper image sub-sensor and the lower diffusive surface is within the field of view of the lower image sub-sensor. The upper diffusive layer is positioned adjacent to the input surface and the lower diffusive layer is positioned adjacent to a surface of the panel that is opposite to the input surface.

In yet another embodiment, the energy dispersing structure comprises light scattering elements dispersed generally evenly throughout the panel.

According to another aspect there is provided an interactive input system comprising an interactive input device as described above, processing structure communicating with the interactive input device, the processing structure processing data received from the interactive input to determine the location of a pointer relative to the input surface and an image generating device for displaying an image onto the interactive input device that is visible when looking at the input surface.

According to yet another aspect there is provided an interactive input system comprising a panel formed of energy transmissive material and having a contact surface, an energy source directing energy into the panel, the energy being totally internally reflected therein, an energy dispersing layer adjacent a surface of the panel opposite the contact surface, the energy dispersing layer dispersing energy escaping the panel in response to contact with the contact surface and at least one imaging assembly having a field of view looking generally across the energy dispersing layer, at least some of the dispersed energy being directed towards the at least one imaging assembly.

### BRIEF DESCRIPTION OF THE DRAWINGS

Embodiments will now be described more fully with reference to the accompanying drawings in which:

FIG. 1 is a perspective view of an interactive input device with palm reject capabilities;

FIG. 2 is a top plan view of the interactive input device of FIG. 1;

FIG. 3 is a side elevational view of the interactive input device of FIG. 1;

FIG. 4 is a schematic block diagram of an imaging assembly forming part of the interactive input device of FIG. 1;

FIG. 5 is a side elevational view of an active pointer for use with the interactive input device of FIG. 1;

FIG. 6 is an image frame captured by the imaging assembly of FIG. 4;

FIG. 7 is a perspective view of another embodiment of an interactive input device with palm reject capabilities;

FIG. 8 is a side elevational view of the interactive input device of FIG. 7;

FIG. 9 is a perspective view of yet another embodiment of an interactive input device with palm reject capabilities;

FIG. 10 is a side elevational view of the interactive input device of FIG. 9;

FIG. 11 is a perspective view of yet another embodiment of an interactive input device with palm reject capabilities;

FIG. 12 is a top plan view of the interactive input device of FIG. 11;

FIG. 13 is a side elevational view of the interactive input system of FIG. 11;

FIG. 14 is an image frame captured by an imaging assembly of the interactive input device of FIG. 11;

FIG. 15 is a perspective view of yet another embodiment of an interactive input device with palm reject capabilities;

FIG. 16 is a side elevational view of the interactive input device of FIG. 18;

FIG. 17 is a perspective view of yet another embodiment of an interactive input device with palm reject capabilities;

FIG. 18 is a side elevational view of the interactive input device of FIG. 20;

FIG. 19 is a side elevational view of a diffusive layer showing the diffusive pattern of light emitted thereby in response to light emitted by the active pointer of FIG. 5 that impinges on the diffusive layer;

FIG. 20 is a side elevational view of a directional diffusive layer showing the diffusive pattern of light emitted thereby in response to light emitted by the active pointer of FIG. 5 that impinges on the diffusive layer;

FIGS. 21a to 21c are side elevational views of an interactive input system;

FIG. 22 is a perspective view of another interactive input system;

FIG. 23 is a cross-sectional view of FIG. 22 taken along line 23-23; and

FIG. 24 is an enlarged view of a portion of FIG. 23.

### DETAILED DESCRIPTION OF THE EMBODIMENTS

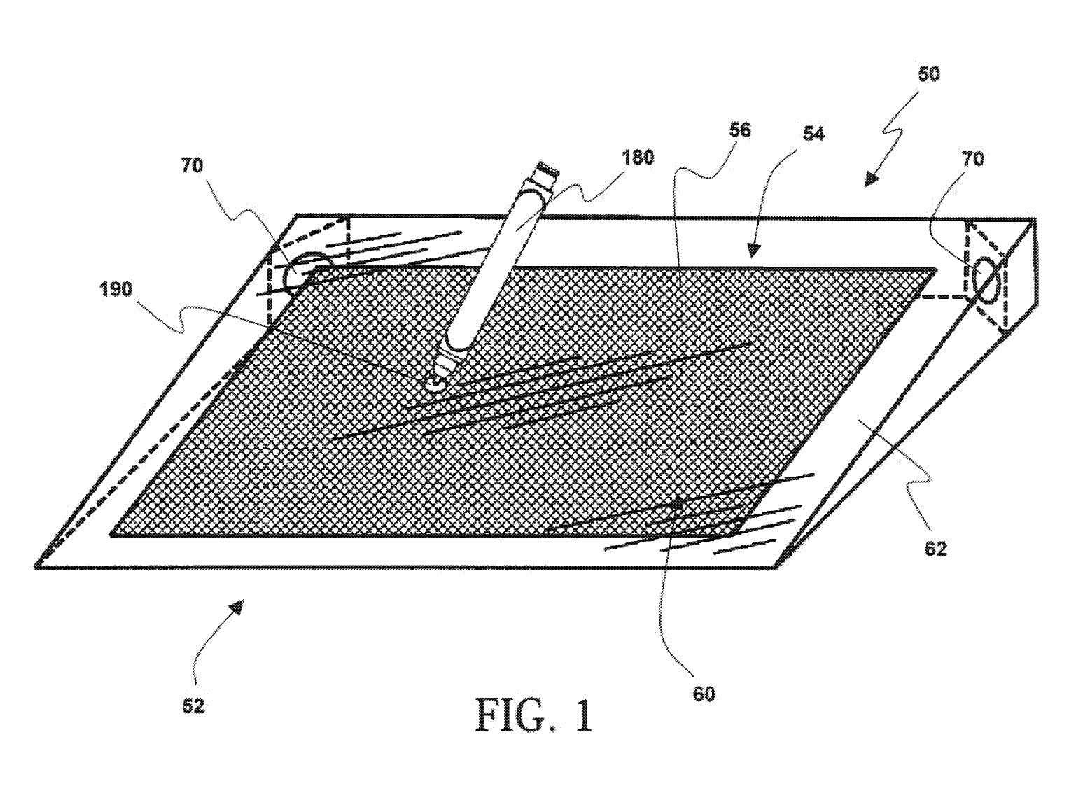

Turning now to FIGS. 1 to 4, a portable interactive input device for use in an interactive input system is shown and is generally identified by reference numeral 50. As can be seen, interactive input device 50 comprises a generally clear panel or tablet 52 formed of energy transmissive material such as for example glass, acrylic or other suitable material. The panel 52 in this embodiment is generally wedged-shaped and provides an inclined, generally rectangular, upper input surface 54 that slopes downwardly from back to front. Energy dispersing structure in the form of a rectangular diffusive layer 56 is embedded in the panel 52 and is positioned slightly below the input surface 54. The diffusive layer 56 in this embodiment is formed of V-CARE® V-LITE® barrier fabric manufactured by Vintex Inc. of Mount Forest, Ontario, Canada and has a footprint that is smaller than the footprint of the input surface 54. The portion of the input surface 54 directly overlying the diffusive layer 56 forms an active input region or area 60 that is surrounded by an inactive border region 62. A pair of imaging assemblies 70 is accommodated by the panel 52. Each imaging assembly 70 is positioned adjacent a different back corner of the panel 52 and is oriented so that the field of view of the imaging assembly 70 is aimed into the panel 52 between the diffusive layer 56 and a bottom surface 72 of the panel 52 and upwardly across the undersurface of the diffusive layer 56.

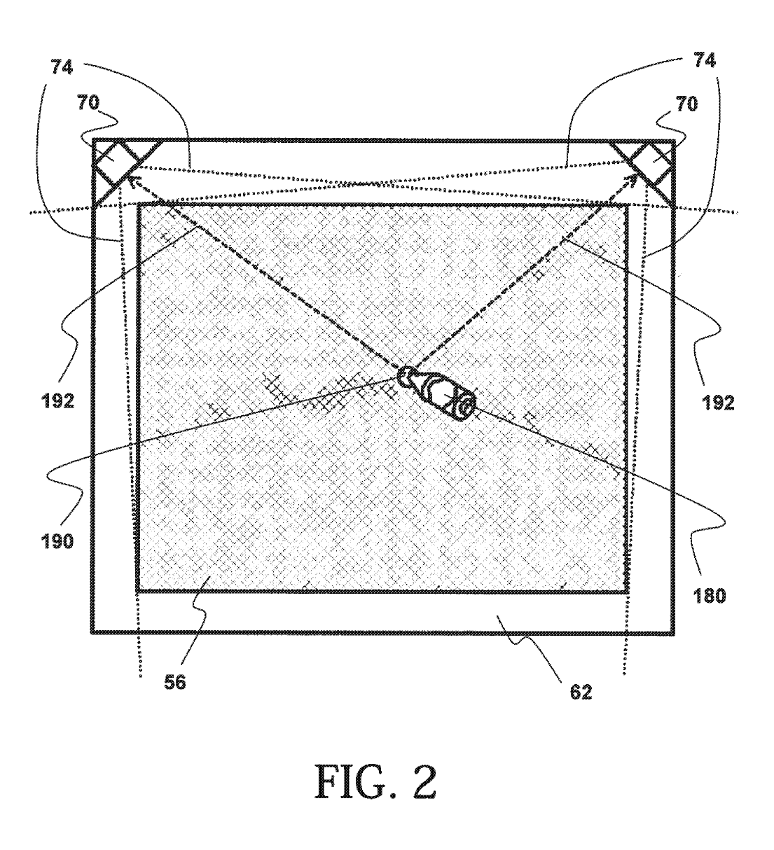

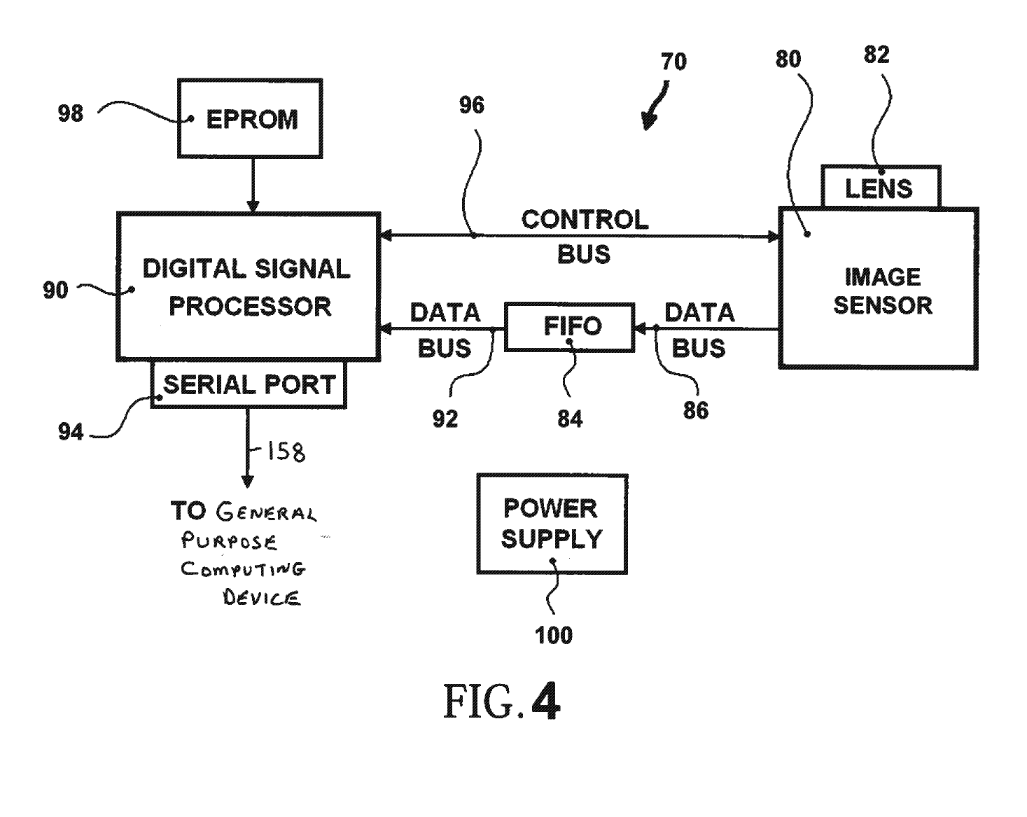

Turning now to FIG. 4, one of the imaging assemblies 70 is better illustrated. As can be seen, the imaging assembly 70 comprises an image sensor 80 such as that manufactured by Micron Technology, Inc. of Boise, Id. under Model No. MT9V022 fitted with an 880 nm lens 82 of the type manufactured by Boowon Optical Co. Ltd. under Model No. BW25B. The lens 82 provides the image sensor 80 with a field of view that is sufficiently wide at least to encompass the active input region 60 as indicated by the dotted lines 74 in FIG. 2. The image sensor 80 communicates with and outputs image frame data to a first-in first-out (FIFO) buffer 84 via a data bus 86. A digital signal processor (DSP) 90 receives the image frame data from the FIFO buffer 84 via a second data bus 92 and provides pointer data to a general purpose computing device (not shown) over a wired or wireless communications channel 158 via an input/output port 94 when a pointer exists in image frames captured by the image sensor 80. For example, the DSP 90 and general purpose computing device may communicate over a serial bus, parallel bus, universal serial bus (USB), Ethernet connection or other suitable wired connection. The image sensor 80 and DSP 90 also communicate over a bi-directional control bus 96. An electronically programmable read only memory (EPROM) 98, which stores image sensor calibration parameters, is connected to the DSP 90. The imaging assembly components receive power from a power supply 100.

Alternatively, the interactive input device 50 may comprise a wireless transceiver communicating with the input/output ports 94 of the imaging assemblies 70 allowing the DSPs 90 and general purpose computing device to communicate over a wireless connection using a suitable wireless protocol such as for example, Bluetooth, WiFi, Zigbee, ANT, IEEE 802.15.4, Z-wave etc.

The general purpose computing device in this embodiment is a personal computer or the like comprising, for example, a processing unit, system memory (volatile and/or non-volatile memory), other non-removable or removable memory (eg. a hard disk drive, RAM, ROM, EEPROM, CD-ROM, DVD, flash memory, etc.) and a system bus coupling the various computer components to the processing unit. The general purpose computing device may also comprise a network connection to access shared or remote drives, one or more networked computers, or other networked devices. Pointer data received by the general purpose computing device from the imaging assemblies 70 is processed to generate pointer location data as will be described.

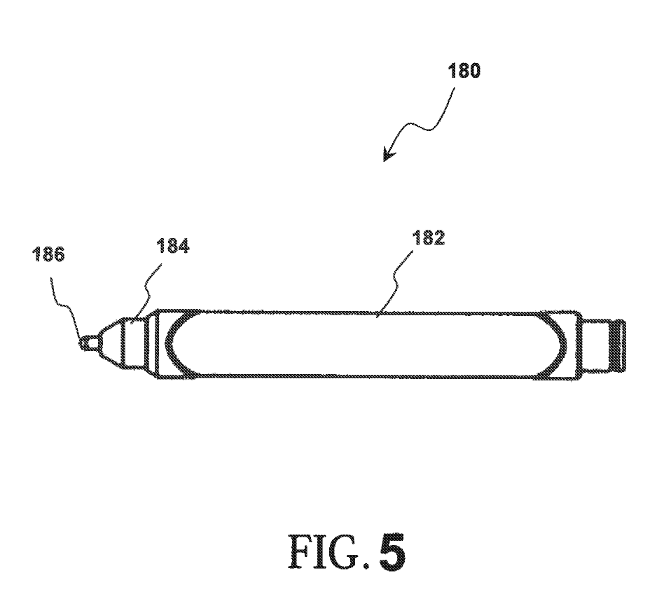

FIG. 5 show an active pointer 180 for use with the interactive input device 50. The pointer 180 has a main body 182 terminating in a frustoconical tip 184. The tip 184 houses one or more miniature infrared light emitting diodes (IR LEDs) (not shown). The infrared LEDs are powered by a battery (not shown) also housed in the main body 182. Protruding from the tip 184 is an actuator 186 that resembles a nib. Actuator 186 is biased out of the tip 184 by a spring (not shown) but can be pushed into the tip 184 upon application of pressure thereto. The actuator 186 is connected to a switch (not shown) within the main body 182 that closes a circuit to power the IR LEDs when the actuator 186 is pushed against the spring bias into the tip 184. With the IR LEDs powered, the pointer 180 emits a narrow beam of infrared light or radiation from its tip 184 represented by the white circle 190 in FIGS. 1 to 3.

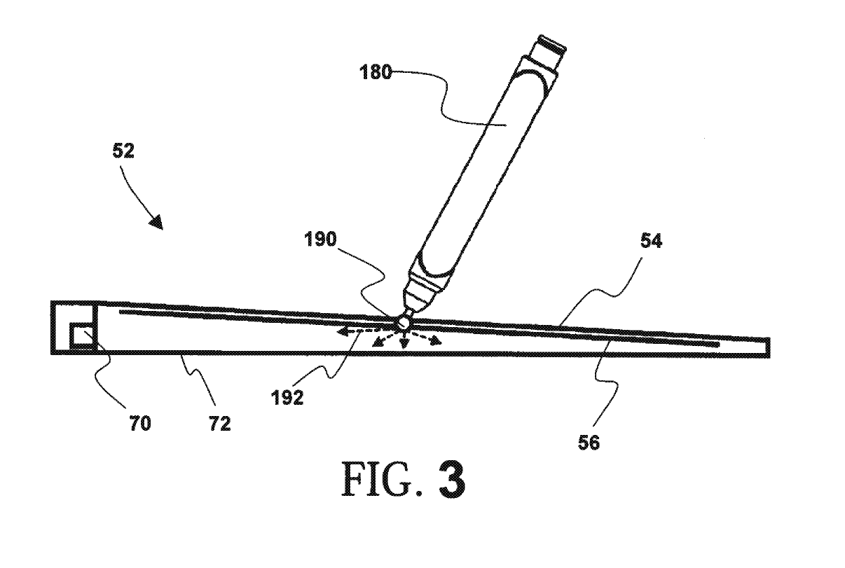

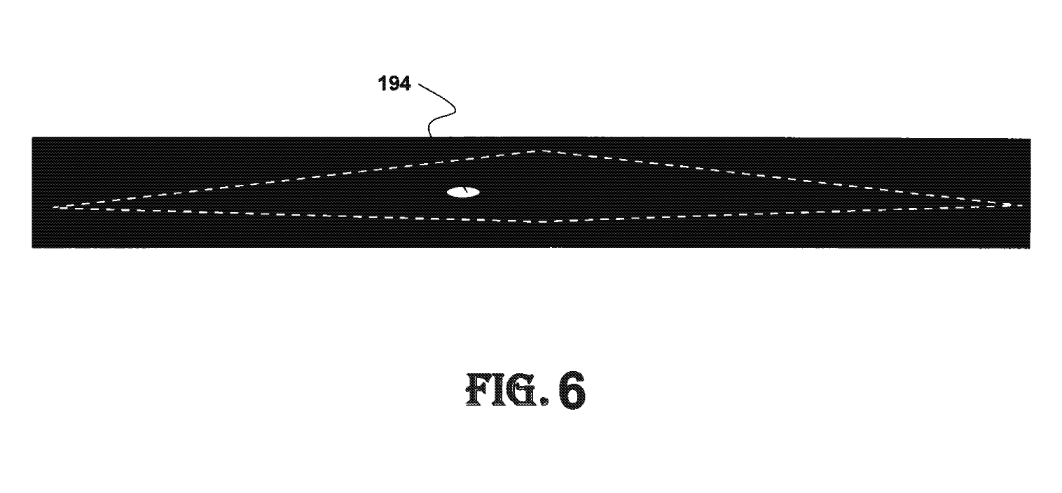

During operation, the DSP 90 of each imaging assembly 70 generates clock signals so that the image sensor 80 of each imaging assembly 70 captures image frames at the desired frame rate. When the pointer 180 is brought into contact with the input surface 54 of the panel 52 with sufficient force to push the actuator 186 into the tip 184 so that the switch connected to the actuator 186 closes, the pointer 180 emits a narrow beam of infrared light that enters into the panel 52. If the pointer 180 contacts the input surface 54 within the active input region 60, the infrared light entering the panel 52 impinges on and is dispersed by the diffusive layer 56 as shown by the arrows 192 in FIG. 3. Some of the dispersed light is directed towards the imaging assemblies 70 and thus, the imaging assemblies 70 see a bright region on the diffusive layer 56. This bright region appears in captured image frames on an otherwise dark background. FIG. 6 shows an image frame captured by one of the imaging assemblies 70 when the pointer 180 is in contact with the active input region 60 of the input surface 54 and its tip 184 is illuminated. As can be seen, the image frame comprises a bright region 194 corresponding to the bright region on the diffusive layer 56. The dotted lines in FIG. 6 represent the boundaries of the active input region 60. If the pointer 180 contacts the input surface 54 within the inactive border region 62, the infrared light entering the panel 52 does not impinge on the diffusive layer 56 and therefore is not dispersed. In this case, the infrared light entering the panel 52 is not seen by the imaging assemblies 70 and as a result captured image frames include only the dark background.

Each image frame output by the image sensor 80 of each imaging assembly 70 is conveyed to its associated DSP 90. When each DSP 90 receives an image frame, the DSP 90 processes the image frame to detect a bright region and hence the existence of the pointer 180. If a pointer exists, the DSP 90 generates pointer data that identifies the position of the bright region within the image frame. The DSP 90 then conveys the pointer data to the general purpose computing device over the communications channel 158 via input/output port 94. If a pointer does not exist in the captured image frame, the image frame is discarded by the DSP 90.

When the general purpose computing device receives pointer data from both imaging assemblies 70, the general purpose computing device calculates the position of the bright region and hence, the position of the pointer 180 in (x,y) coordinates relative to the input surface 54 of the panel 52 using well known triangulation such as that described in above-incorporated U.S. Pat. No. 6,803,906 to Morrison et al. The calculated pointer position is then used to update image output provided to a display unit coupled to the general purpose computing device, if required, so that the image presented on the display unit can be updated to reflect the pointer activity on the active input region 60 of the input surface 54. In this manner, pointer interaction with the active input region 60 of the input surface 54 can be recorded as writing or drawing or used to control execution of one or more application programs running on the general purpose computing device. As will be appreciated, the use of the energy transmissive panel 52 and embedded imaging assemblies 70 and embedded diffusive layer 56 yields a compact, lightweight interactive input device 50 that can be hand carried making it readily transportable and versatile.

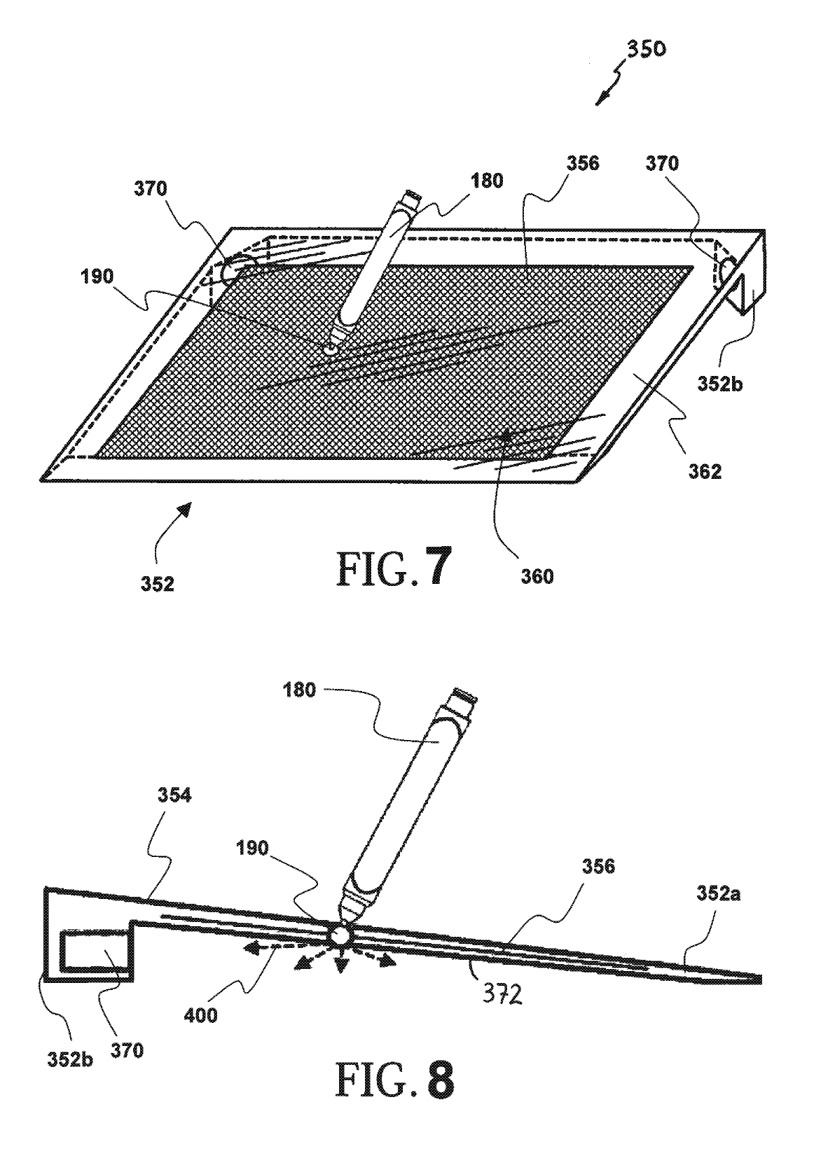

Turning now to FIGS. 7 and 8, another embodiment of an interactive input device is shown and is generally identified by reference numeral 350. In this embodiment, like reference numerals will be used to identify like components with “300” added for clarity. As can be seen, the interactive input device 350 comprises a generally clear panel 352 formed of energy transmissive material such as for example glass, acrylic or other suitable material. The panel 352 comprises a generally planar main body 352a having an upper, generally rectangular input surface 354. Legs 352b that are integrally formed with the main body 352a extend from opposite rear corners of the main body so that when the panel 352 is placed on a generally horizontal support surface such as for example a table top, a desktop or the like, the input surface 354 is downwardly inclined in a direction from back to front. Similar to the previous embodiment, energy dispersive structure in the form of a rectangular diffusive layer 356 is embedded in the panel 352. In this embodiment however, the diffusive layer 356 is positioned slightly above a bottom surface 372 of the main body 352a. The diffusive layer 356 has a footprint that is smaller than the footprint of the input surface 354. The portion of the input surface 354 directly overlying the diffusive layer 356 forms an active input region or area 360 that is surrounded by an inactive border region 362. An imaging assembly 370 is accommodated by each leg 352b of the panel 352 and is oriented so that the field of view of the imaging assembly 370 is aimed into the space beneath the bottom surface 372 of the main body 352a of the panel and upwardly across the bottom surface 372 of the main body 352a. The imaging assemblies 370 are the same as the imaging assemblies 70 and capture image frames in response to clock signals generated by the DSP 90.

The operation of the interactive input device 350 is very similar to that of the previous embodiment. When the pointer 180 is brought into contact with the input surface 354 with sufficient force to push the actuator 186 into the tip 184 so that the switch connected to the actuator 186 closes, the pointer 180 emits a narrow beam of infrared light that enters into the panel 352. If the pointer 180 contacts the input surface 354 within the active input region 360, the infrared light entering the panel 352 impinges on and is dispersed by the diffusive layer 356 as shown by the arrows 400 in FIG. 8. Some of the dispersed light is directed towards the imaging assemblies 370 and thus, the imaging assemblies 370 see the bright region on the diffusive layer 356 illuminated by the pointer 180. This bright region appears in captured image frames on an otherwise dark background. If the pointer 180 contacts the input surface 354 within the inactive border region 362, the infrared light entering the panel 352 does not impinge on the diffusive layer 356 and therefore is not dispersed. As a result, the infrared light entering the panel 352 is not seen by the imaging assemblies 370. Image frames captured by the image sensors 80 of the imaging assemblies 370 and pointer data output by the imaging assemblies 370 are processed in the same manner as described above.

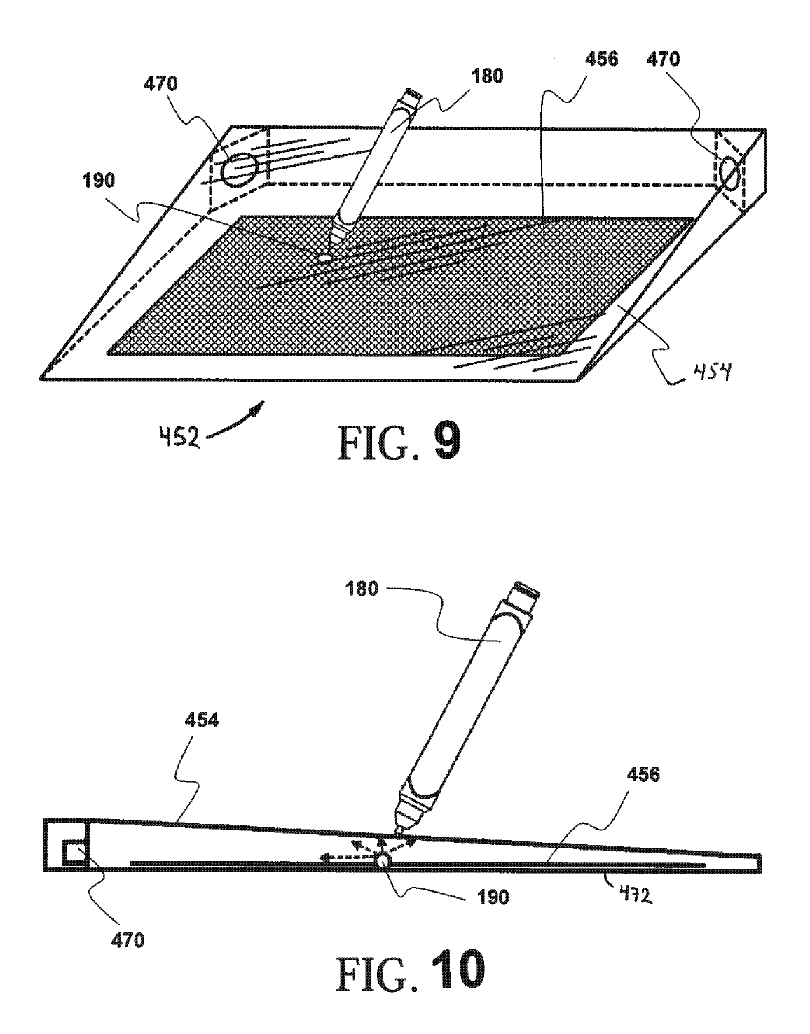

FIGS. 9 and 10 show yet another embodiment of an interactive input device that is very similar to the interactive input devices described previously. In this embodiment, the panel 452 is wedge-shaped similar to panel 52 and provides an inclined, generally rectangular, upper input surface 454. The diffusive layer 456 embedded in the panel 452 is positioned slightly above the bottom surface 472 of the panel 452 and has a footprint that is smaller than the input surface 454 to define active input and inactive border regions. A pair of imaging assemblies 470 is accommodated by the panel 452, with each imaging assembly being positioned adjacent a different back corner of the panel 452. Each imaging assembly 470 is oriented so that its field of view is aimed into the panel 452 between the input surface 454 and the diffusive layer 456 and downwardly across the diffusive layer 456. The imaging assemblies 470 are the same as the imaging assemblies 70 and capture image frames in response to clock signals generated by the DSP 90. Image frames captured by the image sensors 80 of the imaging assemblies 470 and pointer data output by the imaging assemblies 470 are processed in the same manner as described above.

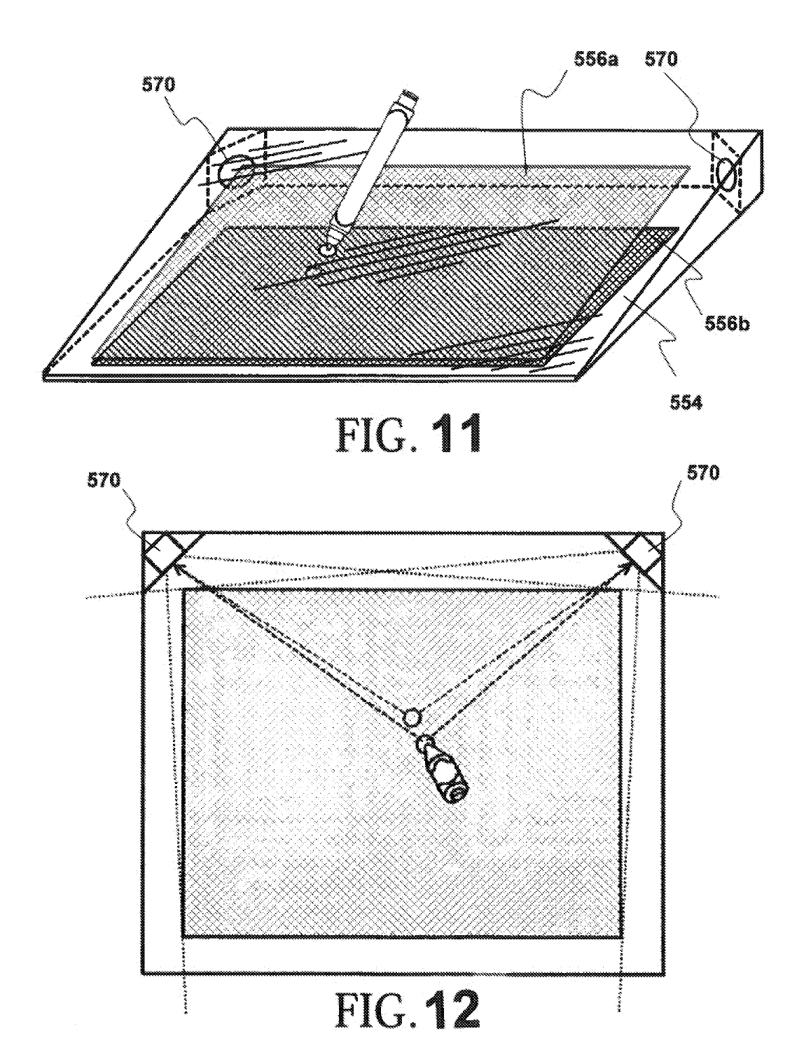

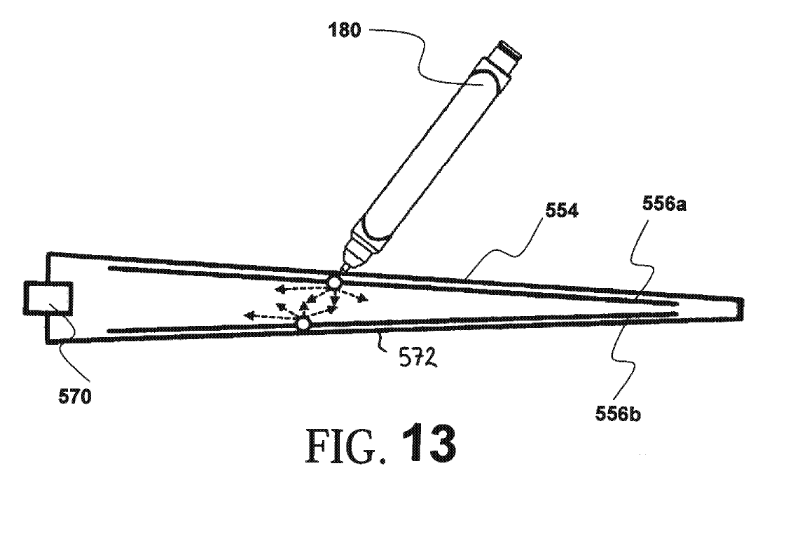

FIGS. 11 to 13 show yet another embodiment of an interactive input device. Rather than employing a single diffusive layer embedded in the panel, in this embodiment, spaced upper and lower rectangular diffusive layers 556a and 556b, respectively, are embedded in the panel 552. Diffusive layer 556a is positioned slightly below the input surface 554 of the panel 552 and diffusive layer 556b is positioned slightly above the bottom surface 572 of the panel 552. Both the upper and lower diffusive layers 556a and 556b are formed of V-CARE® V-LITE® barrier fabric. Similar to the previous embodiments, the upper diffusive layer 556a has a footprint that is smaller than the footprint of the input surface 554. The portion of the input surface 554 directly overlying the upper diffusive layer 556a forms an active input region or area 560 that is surrounded by an inactive border region 562. The lower diffusive layer 556b also has a footprint that is smaller than the input surface 554. In this embodiment however, the footprint of the lower diffusive layer 556b is larger than the footprint of the upper diffusive layer 556a.

An imaging assembly 570 is positioned adjacent each back corner of the panel 552 and is oriented so that its field of view is aimed into the panel 552 between the upper and lower diffusive layers 556a and 556b, respectively. In this embodiment, the image sensor 80 of each imaging assembly 570 is subdivided into upper and lower sub-sensors. The upper sub-sensor is dedicated to capturing image sub-frames looking generally across the upper diffusive layer 556a and the lower sub-sensor is dedicated to capturing image sub-frames looking generally across the lower diffusive layer 556b.

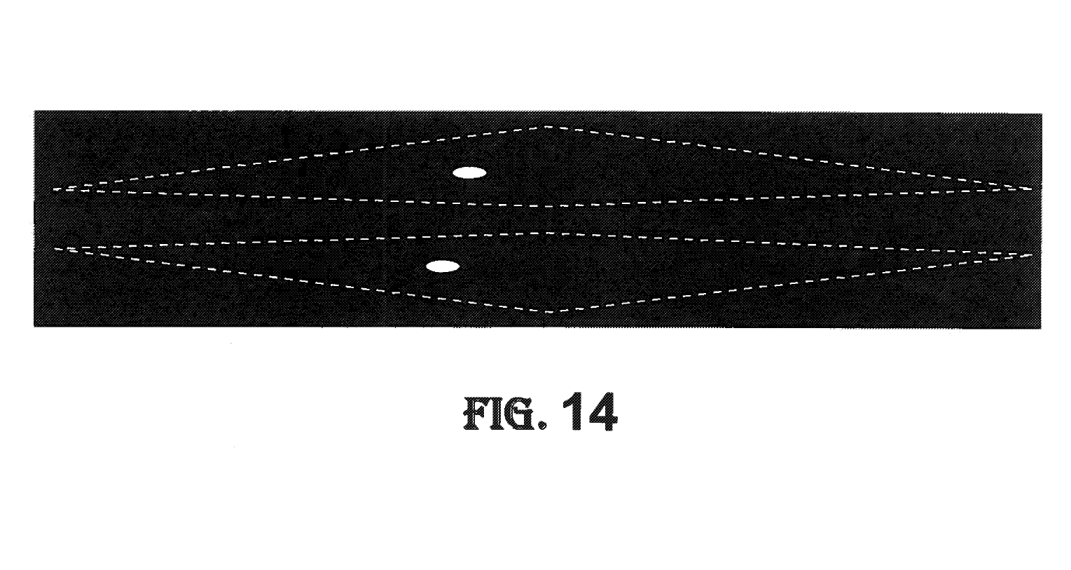

When the pointer 180 is in contact with the input surface 554 of the panel 552 and its tip 184 is illuminated, light emitted by the pointer enters the panel 552 and is partially dispersed by the upper diffuser layer 556a resulting in a bright region appearing on the upper diffusive layer. The nature of the upper diffusive layer 556a ensures that some infrared light emitted by the pointer 180 passes through the upper diffusive layer 556a and impinges on the lower diffusive layer 556b. The light impinging on the lower diffusive layer 556b is dispersed by the lower diffusing layer resulting in a bright region appearing thereon. During image frame capture, each image sub-frame captured by the upper sub-sensor of each imaging assembly 570 will comprise a bright region corresponding to the bright region on the upper diffusive layer 556a. Likewise, each image sub-frame captured by the lower sub-sensor of each imaging assembly 570 will comprise a bright region corresponding to the bright region on the lower diffusive layer 556b. FIG. 14 shows an image frame comprising upper and lower sub-frames. As can be seen, the upper image sub-frame comprises a bright region corresponding to the bright region on the upper diffusive layer 556a on an otherwise dark background and the lower image sub-frame comprises a bright region corresponding to the bright region on the lower diffusive layer 556b on an otherwise dark background.

The upper image sub-frames captured by the upper sub-sensor of each imaging assembly 570 are processed in a similar manner to that described above so that pointer data representing the bright region in each upper image sub-frame is generated. The pointer data from each imaging assembly 570 is also processed by the general purpose computing device in the manner described above to calculate the position of the bright region on the upper diffusive layer 556a and hence the position of the pointer 180 in (x, y) coordinates relative to the input surface 554 of the panel 552. The lower image sub-frames captured by the lower sub-sensor of each imaging assembly 570 are processed in the same manner to calculate the position of the bright region on the lower diffusive layer 556b. After the general purpose computing device determines the coordinates for the bright regions in both the upper and lower diffusive layers 556a and 556b respectively, with the angles of the planes of the upper and lower diffusive layers 556a and 556b known, the general purpose computing device uses the angles and the (x, y) coordinates of the bright regions to calculate the angle of the pointer 180.

As will be apparent to those of skill in the art, by using a lower diffusive layer 556b with a larger footprint than the upper diffusive layer 556a, the angle of the pointer 180 can be calculated even when the pointer is positioned adjacent the periphery of the upper diffusive layer 556a and is angled toward the periphery of the input surface 554. If determining the angle of the pointer 180 is not of concern when the pointer is positioned near the periphery of the upper diffusive layer 556a, the footprints of the upper and lower diffusive layers 556a and 556b can be the same or if pointer angle information is only important when the pointer is within a specified region of the panel 552, the footprint of the lower diffusive layer 556b can be smaller than the footprint of the upper diffusive layer 556a. If desired, the upper diffusive layer 556a can be made more transparent than the lower diffusive layer 556b to ensure sufficient light passes through the upper diffusive layer 556a and impinges on the lower diffusive layer 556b.

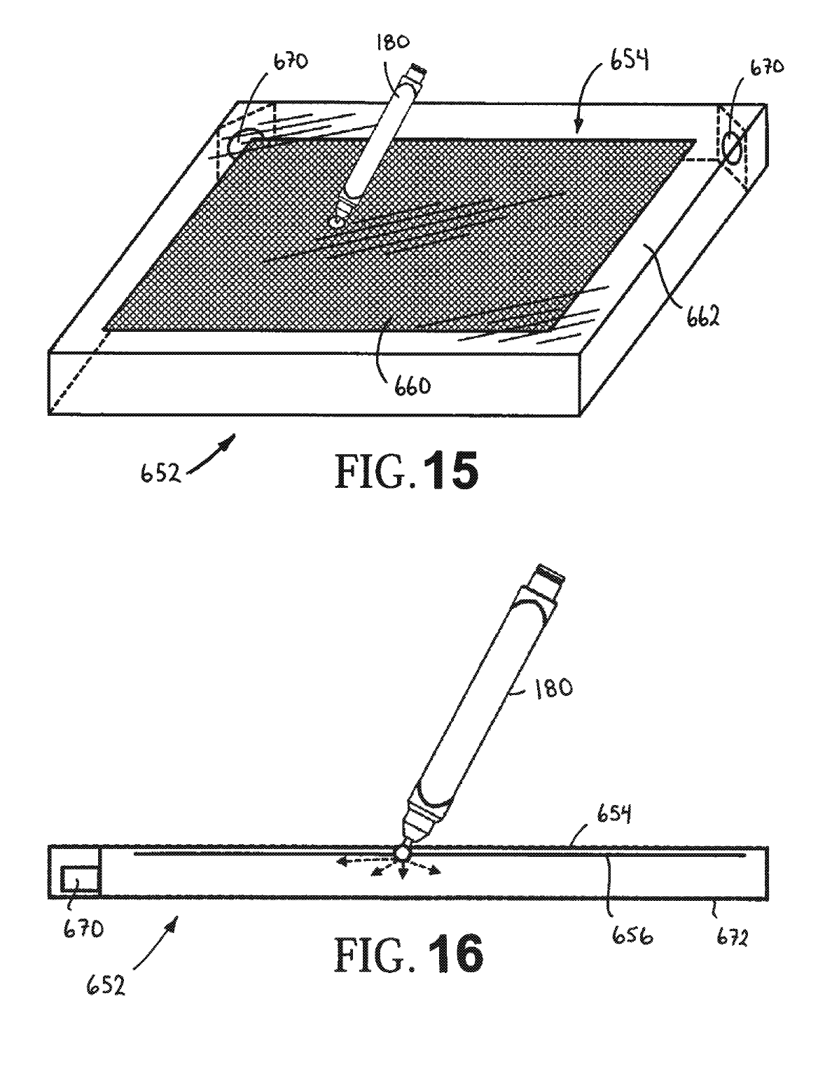

FIGS. 15 and 16 show yet another embodiment of an interactive input device similar to that of FIGS. 1 to 4. In this embodiment, the interactive input system comprises a generally rectangular, clear panel 652 formed of energy transmissive material such as glass, acrylic or the like that provides a generally horizontal upper input surface 654 when the panel is placed on a horizontal support surface such as a table top, desktop or the like. Energy dispersing structure in the form of a diffusive layer 656 is embedded in the panel 652 and is positioned slightly below the input surface 654. The diffusive layer 656 has a footprint that is smaller than the footprint of the input surface 654. The portion of the input surface 654 directly overlying the diffusive layer 656 forms an active input region or area 660 that is surrounded by an inactive border region 662. A pair of imaging assemblies 670 is accommodated by the panel 652. Each imaging assembly 670 is positioned adjacent a different back corner of the panel 652 and is oriented so that its field of view is aimed into the panel 652 between the diffusive layer 656 and a bottom surface 672 of the panel 652 and upwardly across the undersurface of the diffusive layer 656. The imaging assemblies 670 are the same as the imaging assemblies 70 and capture image frames in response to clock signals generated by the DSP 90. Image frames captured by the image sensors 80 of the imaging assemblies 670 and pointer data output by the imaging assemblies 670 are processed in the same manner as described above.

If desired, the diffusive layer 656 may be positioned adjacent the bottom surface 672 of the panel 652. In this case, each imaging assembly 670 is oriented so that its field of view is aimed into the panel between the input surface 654 and the diffusive layer 656 and downwardly across the diffusive layer 656.

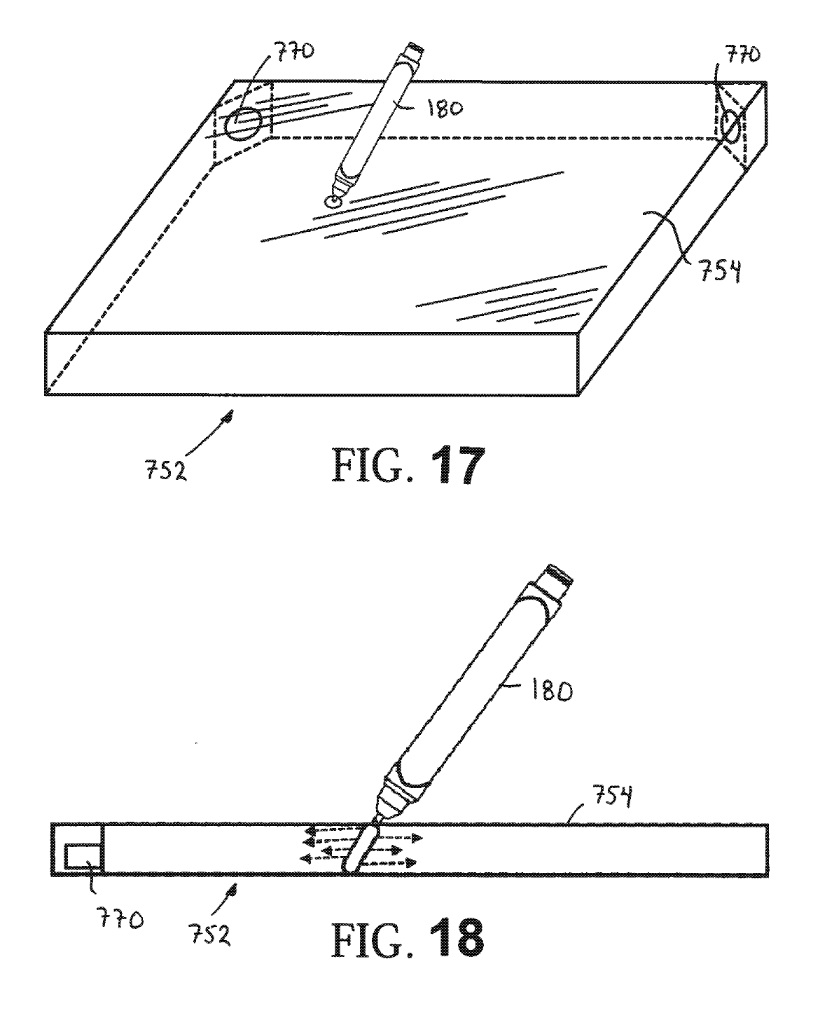

Rather than using one or more discrete diffusive layers, the interactive input device may comprise a panel that is internally configured to disperse light entering the panel. Turning now to FIGS. 17 and 18, an interactive input device is shown comprising a panel 752 made from of a heterogeneous mixture of energy transmitting material, such as glass or acrylic, and light scattering elements, such as aluminum powder or air bubbles that are suspended generally uniformly throughout the energy transmitting material. A pair of imaging assemblies 770 is accommodated by the panel 752, with each imaging assembly 770 being positioned adjacent a different back corner of the panel 752. Each imaging assembly 770 is oriented so that its field of view is aimed into the panel 752. The imaging assemblies 770 are the same as the imaging assemblies 70 and capture image frames in response to clock signals generated by the DSP 90. Image frames captured by the image sensors 80 of the imaging assemblies 770 and pointer data output by the imaging assemblies 770 are processed in the same manner as described above.

When the pointer 180 is brought into contact with the upper surface 754 of the panel 752 with sufficient force to push the actuator 186 into tip 184 so that the switch connected to the actuator 186 closes, the pointer 180 emits a narrow beam of infrared light that enters into the panel 752. The infrared light travels uninterrupted through the energy transmitting material until being reflected off of the light scattering elements generally uniformly dispersed throughout the panel 752. Some of the infrared light scattered by the light scattering elements is directed towards the imaging assemblies 770 resulting in a cone of light that appears in image frames captured by the imaging assemblies 770.

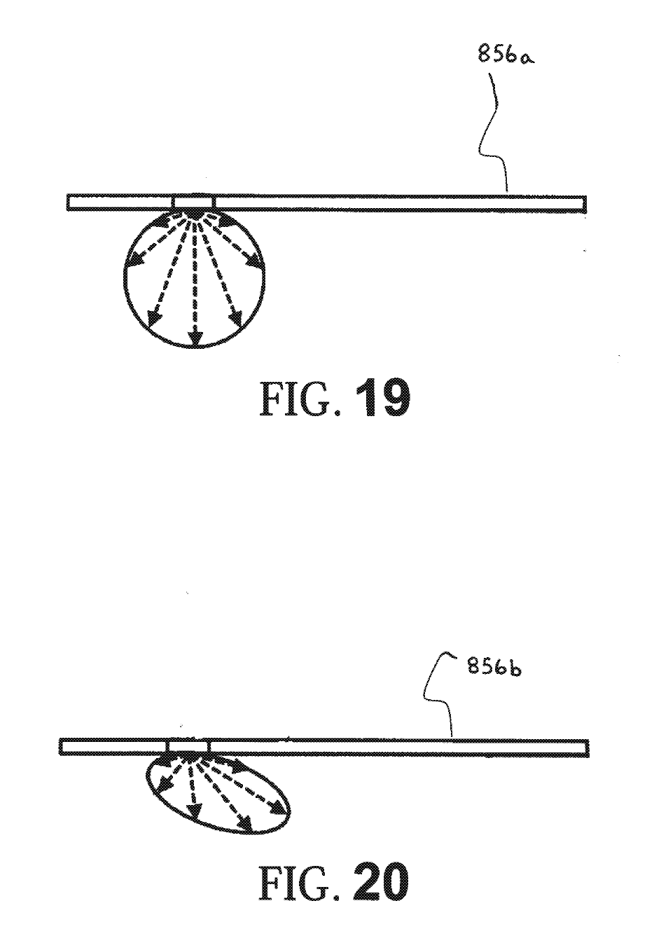

FIG. 19 shows a diffusive layer 856a such as those employed in the interactive input devices of FIGS. 1 to 14 illustrating the diffusive pattern of light dispersed thereby in response to light emitted by the pointer 180 that impinges on the diffusive layer. As can be seen, some of the light passing through the diffusive layer 856a is scattered generally perpendicular to the diffusive layer. In this case, an imaging assembly having a field of view aimed across the undersurface of the diffusive layer captures only a small amount of the light scattered by the diffusive layer. Lower amounts of light captured by the imaging assemblies may lead to low signal-to-noise ratios (SNR), an increase in false positives and poor pointer tracking. To increase the amount of energy directed towards the imaging assembly, a directional diffusive layer may be used in the interactive input devices. Directional diffusive layers are well known in the art and are available from a number of suppliers such as 3M of Minneapolis, Minn., U.S.A. FIG. 20 shows a directional diffusive layer 856b illustrating the diffusive pattern of light dispersed thereby in response to light emitted by the pointer 180 that impinges on the diffusive layer. In this case, less light is scattered generally perpendicular to the diffusive layer resulting in more light being captured by the imaging assembly. The increase in captured light improves SNR and pointer tracking.

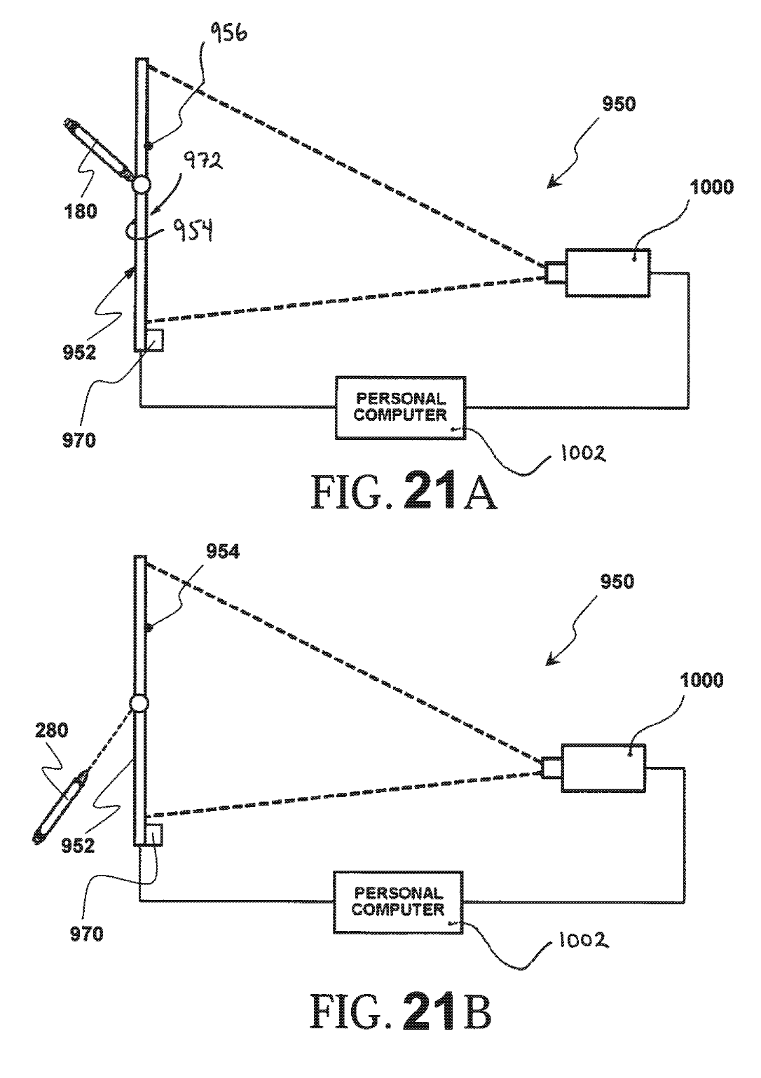

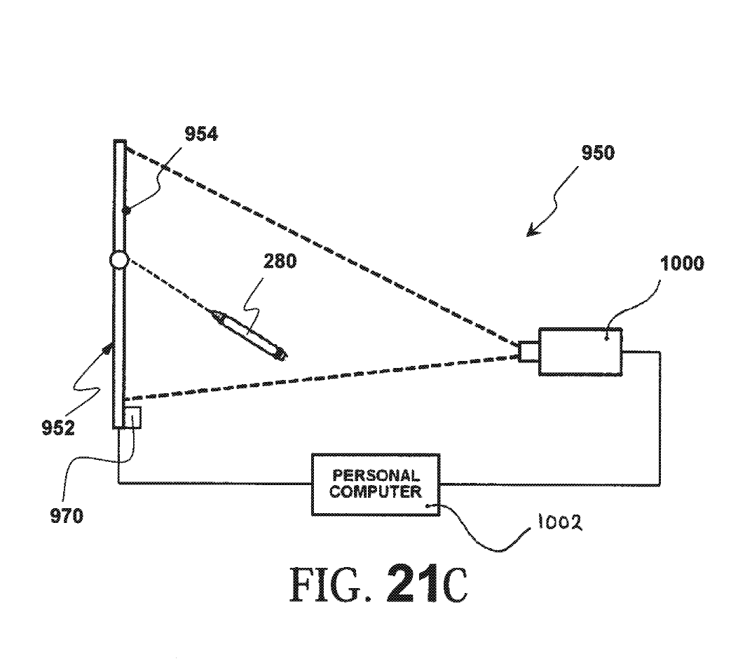

Turning now to FIGS. 21a and 21b, an interactive input system is shown and is generally identified by reference numeral 950. As can be seen, interactive input system 950 comprises a panel 952 mounted vertically such as for example on a wall surface or supported by a stand. The panel 950 is generally rectangular and provides a generally vertical input surface 954. Energy dispersing structure in the form of a diffusive layer 956 is disposed on the rear surface 972 of the panel. In this embodiment, the diffusive layer 956 has a footprint that is of the same size as the input surface 954. A pair of imaging assemblies 970 (only one of which is shown) is mounted on the rear surface 972 of the panel 952. Each imaging assembly 970 is positioned adjacent a different bottom corner of the panel 952 and is oriented so that its field of view looks upwardly into the region behind the panel 952 and forwardly across the diffusive layer 956. The imaging assemblies 970 are the same as the imaging assemblies 70 and capture image frames in response to clock signals generated by the DSP 90. A projector 1000 is positioned behind the panel 952 and projects an image onto the diffusive layer 956 that is visible when looking at the input surface 954. A general purpose computing device 1002 communicates with the imaging assemblies 970 and with the projector 1000 and provides image data to the projector that is used to generate the projected image. FIG. 21a shows the interactive input system 950 used in conjunction with the pointer 180 while FIG. 21b shows the interactive input system 950 used in conjunction with a laser pointer 280.

The operation of the interactive input system 950 is very similar to the previous embodiments. When the pointer 180 or laser 280 is conditional to emit a narrow beam of light that enters the panel 952 via the input surface 954, the light passing through the panel 952 impinges on the diffusive layer 956 and is dispersed creating a bright region on the diffusive layer that is seen by the imaging assemblies 970 and captured in image frames. Pointer data output by the imaging assemblies 970, following processing of image frames, is processed by the general purpose computing device 1002 in the same manner as described above. The calculated pointer position is then used to update image output provided to the projector 1000, if required, so that the image projected onto the diffusive layer 956 can be updated to reflect the pointer activity. In this manner, pointer interaction with the input surface 954 can be recorded as writing or drawing or used to control execution of one or more application programs running on the general purpose computing device 1002.

The projector 1000 does not need to project the image from the rear. Rather, the interactive input system 950 can be operated in a front projection mode as shown in FIG. 21c. In this case, the projector 1000 is positioned on the same side of the panel 952 as the imaging assemblies 970 and projects an image on the panel surface. The pointer 180 or laser pointer 280 can then be used to direct light into the panel 952 allowing a user to interact with the panel.

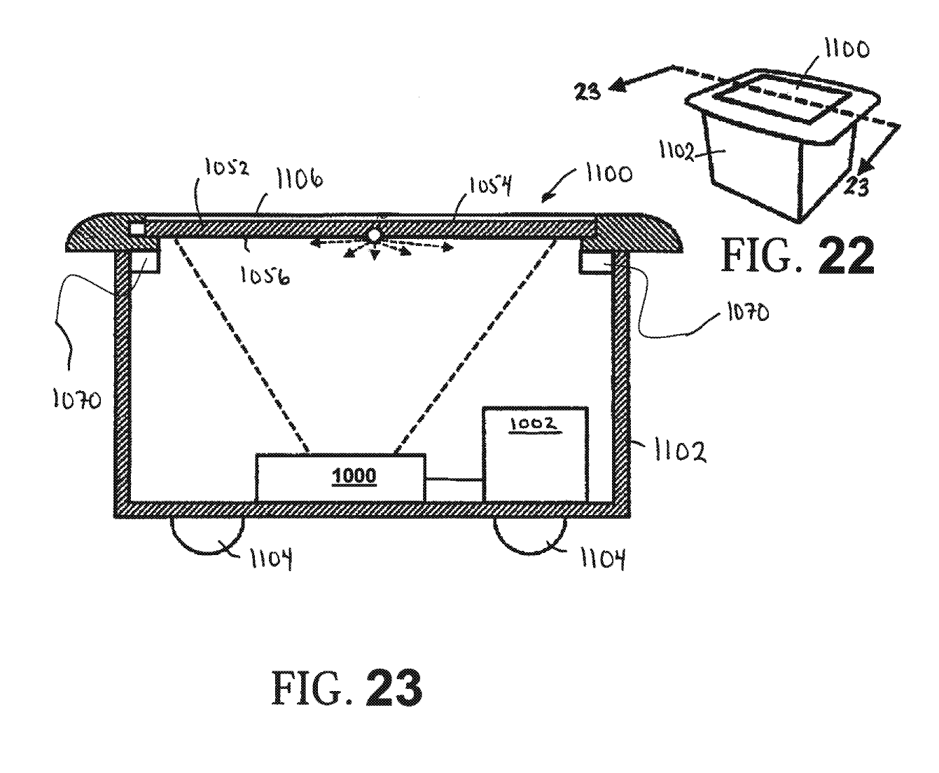

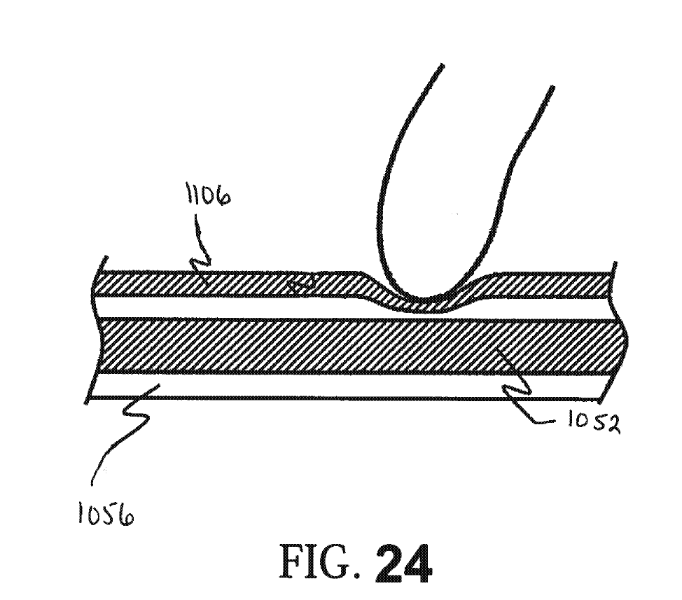

FIGS. 22 to 24 show another embodiment of an interactive input system. In this embodiment, the interactive input system 1050 is in the form of a touch table. Touch table comprises a table top 1100 mounted atop a cabinet 1102. The cabinet 1102 sits on wheels, castors or the like 1104 that enable the touch table to be easily moved from place to place as needed. Integrated into the table top is a panel 1052 formed of energy transmissive material such as for example glass, acrylic or other suitable material having an upper input surface 1054. Along one edge of the energy transmissive panel is a row of IR LEDs (not shown) that flood the interior of the panel 1052 with light. The other edges of the panel 1052 are coated in a light reflecting material so that the energy emitted by the row of IR LEDs is totally internally frustrated within the panel 1052. Similar to the previous embodiment, energy dispersing structure in the form of a rectangular, diffusive layer 1056 is embedded in the panel 1052 and is positioned slightly above the bottom surface of the panel. A pair of imaging assemblies 1070 is accommodated within the cabinet 1102. Each imaging assembly 1070 is positioned adjacent a different upper corner of the cabinet 1102 and is oriented so that its field of view is aimed into the space beneath the panel and upwardly across the diffusive layer 1056. The imaging assemblies 1070 are the same as the imaging assemblies 70 and capture image frames in response to clock signals generated by the DSP 90. A flexible layer 1106 is positioned above the panel 1052 and can be biased into contact with the upper surface of the panel.

The cabinet 1102 also houses a general purpose computing device 1002 and a vertically-oriented projector 1000. The projector 1000 is aimed to project an image directly onto the bottom surface of the panel 1052 that is visible through the panel from above. The projector 1000 and the imaging assemblies 1070 are each connected to and managed by the general purpose computing device 1002. A power supply (not shown) supplies electrical power to the electrical components of the touch table. The power supply may be an external unit or, for example, a universal power supply within the cabinet for improving portability of the touch table. Heat managing provisions (not shown) are also provided to introduce cooler ambient air into the cabinet while exhausting hot air from the cabinet. For example, the heat management provisions may be of the type disclosed in U.S. patent application Ser. No. 12/240,953 to Sirotich et al. filed on Sep. 29, 2008 entitled “Touch Panel for an Interactive Input System, and Interactive System Incorporating the Touch Panel”, assigned to SMART Technologies ULC of Calgary, Alberta, assignee of the subject application, the content of which is incorporated herein by reference in its entirety.

When a user presses on the flexible layer 1106 and it comes into contact with the panel 1056, totally internally frustrated light reflects off the point of contact and impinges on the diffusive layer 1056 as the light exits the bottom surface of the panel 1052 resulting in the exiting light being dispersed. Some of the dispersed light is directed towards the imaging assemblies 1070 and captured in image frames. Pointer data output by the imaging assemblies 1070, following processing of image frames, is processed by the general purpose computing device 1002 in the same manner as described above. The calculated pointer position is then used to update image output provided to the projector 1000, if required, so that the image presented on the panel 1052 can be updated to reflect the pointer activity. In this manner, pointer interaction with the flexible layer 1106 can be recorded as writing or drawing or used to control execution of one or more application programs running on the general purpose computing device 1002.

If desired, the IR LEDs of the pointer 180 can be modulated to reduce effects from ambient and other unwanted light sources as described in U.S. Patent Publication Application No. 2009/0278794 to McReynolds et al. entitled “Interactive Input System with Controlled Lighting” filed on May 9, 2008 and assigned to SMART Technologies ULC of Calgary, Alberta, the content of which is incorporated by reference in its entirety.

Although the pointer 180 is described as including a switch that closes in response to the actuator 186 being pushed into the tip, variations are possible. For example, a switch may be provided on the body 182 at any desired location that when actuated, results in the IR LEDs being powered. Alternatively, the IR LEDs may be continuously powered. Also, the pointer 180 need not employ an IR light source. Light sources that emit light in different frequency ranges may also be employed.

Although the diffusive layers in above described embodiments are described as having a footprint smaller than the footprint of the input surface of the panels, those of skill in the art will appreciate that the footprint of the diffusive layers may be equal to the footprint of the input surface of the panels.

Those of skill in the art will also appreciate that other diffusive layer variations may be employed. For example, rather than embedding diffusive layers in the panels, the diffusive layers may be set into recesses formed in the surfaces of the panels so that the diffusive layers are flush with their respective surfaces of the panels 54. Alternatively, the diffusive layers may be adhered or otherwise applied to the respective surfaces of the panels. Further still, the diffusive layers may take the form of coatings applied to the respective surfaces of the panels, or be integrally formed on the respective surfaces of the panels by means such as sandblasting or acid-etching. It may also be advantageous to coat the entire outer surface of the panels in an energy absorbing material, such as black paint, to limit the amount of ambient light that enters the panels. The diffusive layers need not be rectangular but rather, may take on virtually any desired geometric shape.

Those of skill in the art will also appreciate that other processing structures may be used in place of the general purpose computing device. For example, a master controller embedded in the panels may be employed to process pointer data received from the imaging assemblies and in response generate pointer coordinate data that is subsequently conveyed to the general purpose computing device for processing. Alternatively, the master controller or the general purpose computing device may be configured to process the image frame data output by the image sensors both to detect the existence of a pointer in captured image frames and to triangulate the position of the pointer. Rather than using a separate mater controller, the functionality of the master controller may be embodied in the DSP of one of the imaging assemblies. Although the imaging assemblies are described as employing DSPs, other processors such as microcontrollers, central processing units (CPUs), graphics processing units (GPUs), or cell-processors may be used.

Although embodiments have been described above with reference to the drawings, those of skill in the art will appreciate that variations and modifications may be made without departing from the spirit and scope thereof as defined by the appended claims.

What is claimed is:

1. An interactive input device comprising:
a panel formed of energy transmissive material and having an input surface;
energy dispersing structure associated with said panel, said energy dispersing structure dispersing energy emitted by a pointer that enters said panel via said input surface; and
at least one imaging assembly, at least some of the dispersed energy being directed towards said at least one imaging assembly.

2. The interactive input device of claim 1 wherein said energy dispersive structure comprises light diffusive material.

3. The interactive input device of claim 2 wherein said light diffusive material comprises a diffusive layer having a footprint that is the same size or smaller than the footprint of said input surface, said input surface comprising an active input region corresponding generally in size to said diffusive layer.

4. The interactive input device of claim 3 wherein said input surface is inclined.

5. The interactive input device of claim 3 wherein said input surface is generally horizontal.

6. The interactive input device of claim 3 wherein the field of view of said at least one imaging assembly is aimed towards and across said diffusive layer.

7. The interactive input device of claim 6 wherein said diffusive layer is one of: (i) embedded within said panel; (ii) affixed to a surface of said panel; (iii) coated on a surface of said panel; and (iv) integrally formed on a surface of said panel.

8. The interactive input device of claim 7 wherein said diffusive layer is positioned adjacent to said input surface.

9. The interactive input device of claim 7 wherein said diffusive layer is positioned adjacent to a surface of said panel that is opposite to said input surface.

10. The interactive input device of claim 1 comprising at least two spaced imaging assemblies, the imaging assemblies having overlapping fields of view, at least some of the dispersed energy being directed towards said imaging assemblies.

11. The interactive input device of claim 10 wherein said energy dispersive structure is light diffusive material.

12. The interactive input device of claim 11 wherein said light diffusive material comprises a diffusive layer having a footprint that is the same size or smaller than the footprint of said input surface, said input surface comprising an active input region corresponding generally in size to said diffusive layer.

13. The interactive input device of claim 12 wherein said input surface is inclined.

14. The interactive input device of claim 12 wherein said input surface is generally horizontal.

15. The interactive input device of claim 12 wherein the fields of view of said imaging assemblies are aimed towards said diffusive layer.

16. The interactive input device of claim 15 wherein said diffusive layer is one of: (i) embedded within said panel; (ii) affixed to a surface of said panel; (iii) coated on a surface of said panel; and (iv) integrally formed on a surface of said panel.

17. The interactive input device of claim 16 wherein said diffusive layer is positioned adjacent to said input surface.

18. The interactive input device of claim 16 wherein said diffusive layer is positioned adjacent to a surface of said panel that is opposite to said input surface.

19. The interactive input device of claim 10 further comprising processing structure processing image frames captured by the imaging assemblies.

20. The interactive input device of claim 19 wherein said energy dispersive structure is light diffusive material.

21. The interactive input device of claim 20 wherein said light diffusive material comprises a diffusive layer having a footprint that is the same size or smaller than the footprint of said input surface, said input surface comprising an active input region corresponding generally in size to said diffusive layer.

22. The interactive input device of claim 21 wherein said input surface is inclined.

23. The interactive input device of claim 21 wherein said input surface is generally horizontal.

24. The interactive input device of claim 21 wherein the fields of view of said imaging assemblies are aimed towards said diffusive layer.

25. The interactive input device of claim 24 wherein said diffusive layer is one of: (i) embedded within said panel; (ii) affixed to a surface of said panel; (iii) coated on a surface of said panel; and (iv) integrally formed on a surface of said panel.

26. The interactive input device of claim 25 wherein said diffusive layer is positioned adjacent to said input surface.

27. The interactive input device of claim 25 wherein said diffusive layer is positioned adjacent to a surface of said panel that is opposite to said input surface.

28. The interactive input device of claim 2 wherein said light diffusive material comprises spaced upper and lower diffusive layers.

29. The interactive input device of claim 28 wherein said upper and lower diffusive layers are generally parallel.

30. The interactive input device of claim 29 wherein said upper diffusive layer has a footprint that is the same size or smaller than the footprint of said input surface, said input surface comprising an active input region corresponding generally in size to said diffusive layer and wherein said lower diffusive layer has a footprint that is at least as large as the footprint of said upper diffusive layer.

31. The interactive input device of claim 30 wherein said lower diffusive layer has a footprint larger than the footprint of said upper diffusive layer.

32. The interactive input device of claim 30 wherein said input surface is inclined.

33. The interactive input device of claim 30 wherein said input surface is generally horizontal.

34. The interactive input device of claim 30 wherein said at least one imaging assembly comprises upper and lower image sub-sensors, the upper diffusive layer being within the field of view of said upper image sub-sensor and the lower diffusive surface being within the field of view of said lower image sub-sensor.

35. The interactive input device of claim 30 wherein each of said upper and lower diffusive layers is one of: (i) embedded within said panel; (ii) affixed to a surface of said panel; (iii) coated on a surface of said panel; and (iv) integrally formed on a surface of said panel.

36. The interactive input device of claim 35 wherein said upper diffusive layer is positioned adjacent to said input surface and wherein said lower diffusive layer is positioned adjacent to a surface of said panel that is opposite to said input surface.

37. The interactive input device of claim 28 comprising at least two spaced imaging assemblies, the imaging assemblies having overlapping fields of view, each of said imaging assemblies comprising upper and lower image sub-sensors, the upper diffusive layer being within the field of view of said upper image sub-sensor and the lower diffusive surface being within the field of view of said lower image sub-sensor.

38. The interactive input device of claim 37 wherein said upper diffusive layer has a footprint that is the same size or smaller than the footprint of said input surface, said input surface comprising an active input region corresponding generally in size to said diffusive layer and wherein said lower diffusive layer has a footprint that is at least as large as the footprint of said upper diffusive layer.

39. The interactive input device of claim 38 wherein said lower diffusive layer has a footprint larger than the footprint of said upper diffusive layer.

40. The interactive input device of claim 38 wherein said input surface is inclined.

41. The interactive input device of claim 38 wherein said input surface is generally horizontal.

42. The interactive input device of claim 37 wherein each of said upper and lower diffusive layers is one of: (i) embedded within said panel; (ii) affixed to a surface of said panel; (iii) coated on a surface of said panel; and (iv) integrally formed on a surface of said panel.

43. The interactive input device of claim 42 wherein said upper diffusive layer is positioned adjacent to said input surface and wherein said lower diffusive layer is positioned adjacent to a surface of said panel that is opposite to said input surface.

44. The interactive input device of claim 1 wherein said energy dispersing structure comprises light scattering elements dispersed throughout said panel.

45. The interactive input device of claim 44 wherein said light scattering elements are dispersed generally evenly throughout said panel.

46. The interactive input device of claim 43 comprising at least two spaced imaging assemblies, the imaging assemblies having overlapping fields of view aimed into said panel from different vantages.

47. The interactive input device of claim 46 wherein said energy dispersing structure comprises light scattering elements dispersed throughout said panel.

48. The interactive input device of claim 47 wherein said light scattering elements are dispersed generally evenly throughout said panel.

49. The interactive input device of claim 1 wherein said device is portable.

50. The interactive input device of claim 49 further comprising processing structure processing image frames captured by the imaging assemblies.

51. An interactive input system comprising:
an interactive input device according to claim 12;
processing structure communicating with the interactive input device, said processing structure processing data received from said interactive input device to determine the location of a pointer relative to said input surface; and
an image generating device for displaying an image onto said interactive input device that is visible when looking at said input surface.

52. The interactive input device of claim 51 wherein said image generating device is a projector and wherein said panel is vertically mounted.

53. An interactive input system comprising:
a panel formed of energy transmissive material and having a contact surface;
an energy source directing energy into said panel, said energy being totally internally reflected therein;
an energy dispersing layer adjacent a surface of said panel opposite said contact surface, said energy dispersing layer dispersing energy escaping said panel in response to contact with said contact surface; and
at least one imaging assembly having a field of view looking generally across said energy dispersing layer, at least some of the dispersed energy being directed towards said at least one imaging assembly.

54. The interactive input system of claim 53 further comprising a flexible layer spaced from said contact surface and being biasable into contact with said contact surface.

55. The interactive input system of claim 54 comprising at least two imaging assemblies looking generally across said energy dispersing layer from different vantages and having overlapping fields of view.

56. The interactive input system of claim 55 further comprising:
processing structure communicating with the interactive input device, said processing structure processing data received from said interactive input device to determine the location of a contact on said contact surface; and
an image generating device for displaying an image onto said interactive input device that is visible when looking at said contact surface.

57. The interactive input system of claim 56 wherein said panel, energy source, energy dispersing layer, imaging assemblies, processing structure and image generating device are mounted within a table.
